(19) United States
(12) Patent Application Publication
(10) Pub. No.: US 2022/0163309 A1
(43) Pub. Date: May 26, 2022

(54) METHODS AND APPARATUS FOR ESTIMATING MATERIAL SHEET SHAPE

(71) Applicant: Corning Incorporated, Corning, NY (US)

(72) Inventors: John Steele Abbott, III, Elmira, NY (US); Zheming Zheng, Horseheads, NY (US)

(21) Appl. No.: 17/599,089

(22) PCT Filed: Mar. 27, 2020
(86) PCT No.: PCT/US2020/025218

§ 371 Date: Sep. 28, 2021

Related U.S. Application Data
(60) Provisional application No. 62/829,377, filed on Apr. 4, 2019.

(51) Int. Cl. G01B 5/00; G01B 5/28; G01B 21/20

(52) U.S. Cl. CPC G01B 5/0016; G01B 21/20; G01B 5/285; G01B 5/0014

(57) ABSTRACT

Methods and apparatus provide for obtaining a gravity free shape, and intrinsic shape, and a thermal strain of a glass sheet and using same to improve glass manufacturing techniques.

This application claims the benefit of priority under 35 U.S.C. § 119 of U.S. Provisional Application Ser. No. 62/829,377 filed on Apr. 4, 2019, the content of which is relied upon and incorporated herein by reference in its entirety.

### BACKGROUND

Disclosed embodiments relate to methods and apparatus for measuring and estimating shapes of material sheets, such as relatively large glass sheets, particularly relatively large and relatively thin glass sheets.

Producing a commercial product from a larger source sheet of glass, such as a liquid crystal display (LCD), other display glass, etc., involves many challenges. For example, it is important to understand and control the processes used to form large glass sheets (e.g., a down-draw fusion process), and the behavior of the glass sheets during downstream processes (e.g., the behavior of a glass sheet when held in position via a vacuum chuck to a flat plane, when cut, etc.). These challenges are described in detail in U.S. Pat. No. 7,509,218 and International Patent Publication No. WO 2009/108302, the entire disclosures of which are incorporated herein by reference.

In order to better control glass forming and manufacturing processes, there is great value in obtaining knowledge of the gravity-free shape of a large glass sheet, which is an inherently flexible object. Determining the gravity-free shape of large glass sheets has become particularly challenging. As glass manufacturing processes have advanced, the source glass sheets have become larger and thinner. Indeed, in the past, a typical source glass sheet may have been about 1500 mm×1800 mm; however, present technologies are permitting the source glass sheets to be on the order of about nine square meters, such as measuring 2880 mm×3130 mm, and even larger glass sheets are expected in the near future. These glass sheets are of a thickness of about 0.7 mm, where the demand for even thinner glass sheets is increasing.

A known process for determining gravity fee shapes employs a bed-of-nails (BON) technique, for example as detailed in U.S. Pat. Nos. 7,509,218 and 9,031,813, the entire disclosures of which are incorporated herein by reference. The BON technique involves an apparatus having an array of (e.g., about 100) height adjustable pin and load cell combinations. Any of a number of iterative algorithms may be employed to adjust the respective height adjustable pins in response to the measured forces applied to the load cells by the glass sheet. When the iterative algorithm causes the respective heights of the height adjustable pins to result in relatively constant measured target weights by the load cells, then the respective heights of the pins yield the gravity free shape of the glass sheet.

Among the limitations of the BON technique is the size of the array of height adjustable pin and load cell combinations. Indeed, as the source glass sheets increase in size, the available area on BON apparatuses becomes too small to accommodate the source glass sheets.

### SUMMARY

In accordance with one or more aspects of the disclosed embodiments, new techniques are employed to provide a fuller understanding of the shape of a flexible object, such as a glass sheet, which involves not only the gravity free shape, but also an intrinsic shape, and a related characteristic of thermal strain.

One or more embodiments herein may addresses how to estimate both the gravity-free shape and the intrinsic shape of a glass sheet from one or more measurements taken during the BON technique of measuring a gravity free shape.

One or more embodiments herein may address how to estimate the shape and warp characteristics of the glass sheet (and of smaller pieces cut therefrom) from the gravity-free shape of the glass sheet, the intrinsic shape of the glass sheet, and/or the thermal strain of the glass sheet.

One or more embodiments herein may address how to estimate the gravity free shape of a large glass sheet, too large to fit on an available BON apparatus, as a function of the respective intrinsic shapes and thermal strains of a number of smaller pieces cut from the large glass sheet.

Other aspects, features, and advantages will be apparent to one skilled in the art from the description herein taken in conjunction with the accompanying drawings.

### DESCRIPTION OF THE DRAWINGS

For the purposes of illustration, there are forms shown in the drawings that are presently preferred, it being understood, however, that the embodiments disclosed and described herein are not limited to the precise arrangements and instrumentalities shown.

FIG. 1A is a schematic illustration of a glass sheet disposed on a BON apparatus, specifically at an initial iteration where all the height adjustable pins of the BON apparatus are at a constant height (flat);

FIG. 1B is a schematic illustration of the glass sheet disposed on the BON apparatus if FIG. 1A, specifically at a final iteration of an algorithm where all the height adjustable pins of the BON apparatus are indicative of a gravity free shape of the glass sheet;

FIGS. 2A, 2B, 2C, and 2D illustrate respective stages in a stitching process, whereby a larger glass sheet is cut into smaller pieces, respective gravity free shapes of the smaller pieces are obtained, and an estimate of a gravity free shape of the original glass sheet is estimated;

FIG. 3A is a representative graph of changes in pin height (Y-axis) in a BON apparatus as a function if iteration (X-axis);

FIG. 3B is a representative graph of weight error (Y-axis) in the BON apparatus of FIG. 3A as a function if iteration (X-axis);

FIG. 4A is a representative shaded schematic diagram of an actual gravity free shape of a glass sheet, which is dome shaped;

FIG. 4B is a representative shaded schematic diagram of an estimated intrinsic shape of the glass sheet;

FIG. 4C is a representative shaded schematic diagram of an estimated thermal strain of the glass sheet; and

FIG. 4D is a representative shaded schematic diagram of an estimation of the gravity free shape of the glass sheet of FIG. 4A, computed based on the estimated intrinsic shape of FIG. 4B and the estimated thermal strain of FIG. 4C.

### DETAILED DESCRIPTION OF THE PREFERRED EMBODIMENTS

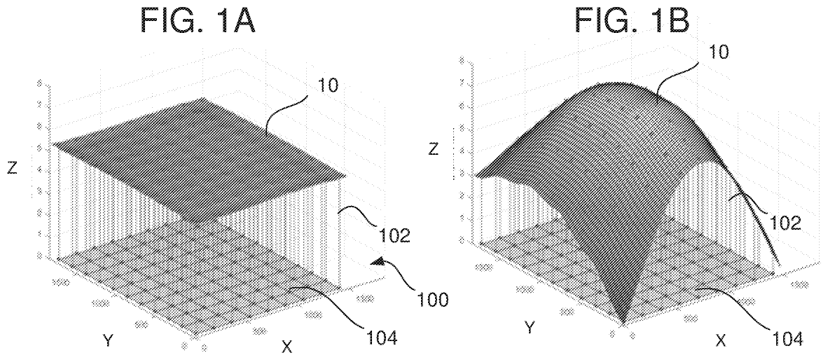

With reference to the drawings wherein like numerals indicate like elements there is shown in FIG. 1A is a schematic illustration of a glass sheet 10 disposed on a BON apparatus 100, specifically at an initial iteration where all the height adjustable pins 102 of the BON apparatus 100 are at a constant height (i.e., flat). As mentioned previously, each of the height adjustable pins 102 is associated with a respective load cell 104, which are arranged in a X-Y array (e.g., a 9×11 array). The respective heights of the height adjustable pins 102 are measured along the Z direction (e.g., usually in mm).

FIG. 1B is a schematic illustration of the glass sheet 10 on the BON apparatus 100 if FIG. 1A, specifically at a final iteration of an algorithm where all the height adjustable pins 102 of the BON apparatus 100 are indicative of a gravity free shape of the glass sheet 10.

The BON process involves computing/estimating a set of target weights (e.g., a constant) which the glass sheet 10 would impose on the load cells 104 if the glass sheet 10 were perfectly flat (i.e., having a perfectly flat gravity free shape) and if the height adjustable pins 102 of the array were perfectly flat. Since the glass sheet 10 is not perfectly flat, the actual initial weights measured at the initial iteration (FIG. 1) where all the height adjustable pins 102 of the BON apparatus 100 are constant (i.e., flat) do not match the target weights. Thus, the respective heights of the height adjustable pins 102 of the BON apparatus 100 cannot be constant (and must be changed) in order for the actual measured weights on the load cells 104 to match the target weights.

Any of a number of iterative algorithms may be employed to compute changes in the respective heights of the height adjustable pins 102 based on measured weights on the load cells at each iteration. The iterative algorithm is employed to converge on a final set of respective heights of the height adjustable pins 102 such that the actual measured weights on the load cells 104 match the target weights. The final set of respective heights is reflective of the (non-flat) gravity free shape of the glass sheet 10. The determined gravity free shape may be confirmed or tested by flipping the glass sheet 10 over to the other side and again running the BON process. The gravity free shape is confirmed if both BON processes result in substantially the same gravity free shape.

As noted above, one of the limitations of a given BON apparatus 100 is the limited size of the array of height adjustable pins 102 and associated load cells 104. In the case of the illustrated embodiment of FIGS. 1A, 1B, the arrangement of a 9×11 array capable of measuring glass sheets on the order of about 1500 mm×1800 mm. Thus, directly measuring the gravity free shape of a larger glass sheet (e.g., about 2880 mm×3130 mm) by placing the entire glass sheet on the BON apparatus 100 shown in FIGS. 1A, 1B is not possible.

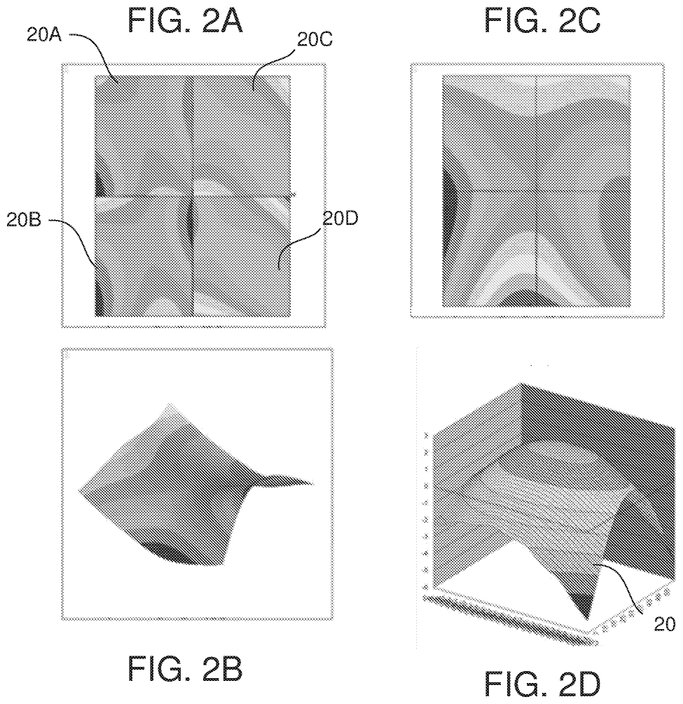

With reference to FIGS. 2A, 2B, 2C, and 2D, a discussion of a known attempt at a solution to the above problem will be presented. The thrust of the attempted solution provides for: (i) cutting the larger glass sheet into smaller pieces; (ii) measuring the gravity free shape of each of the smaller sheets on the BON apparatus 100; (iii) mathematically stitching the gravity free shapes of each of the smaller pieces together to estimate the gravity free shape of the larger glass sheet (if it were not cut). FIGS. 2A, 2B, 2C, and 2D illustrate respective stages in the noted stitching process, whereby a glass sheet 20 (which is larger than the available area of the BON apparatus 100) is cut into smaller pieces 20A, 20B, 20C, 20D. FIG. 2A shows the respective gravity free shape of each piece obtained separately using the BON apparatus 100. FIG. 2A shows a top-down (shaded) view of the respective gravity free shapes, while FIG. 2B is a representative perspective view of the gravity free shape of the smaller pieces 20A, 20B, 20C, 20D. FIGS. 2A and 2B reveal that the gravity free shape of each of the smaller pieces 20A, 20B, 20C, 20D is generally saddle shaped.

FIG. 2C shows the resultant estimation of the gravity free shape of the larger glass sheet 20 using a known stitching process (or script), which is a mathematical process where each of the respective gravity free shapes of the smaller pieces 20A, 20B, 20C, 20D are matched at respective edges thereof. While the result illustrated in FIG. 2C is interesting, it does not match the actual gravity free shape of the glass sheet 20, which is illustrated in FIG. 2D, and is generally dome shaped.

It has been discovered that for some types of glass sheets, the relatively large glass sheet 20 exhibits a gravity free shape that is generally dome shaped; however, when cut into smaller pieces, each piece has a gravity free shape that is generally saddle shaped. It is believed that these characteristics result from a fusion draw process during the manufacture of the glass sheet 20. Thus, when cutting small pieces of glass for a commercial application from the larger glass sheet 20 (which has been fusion drawn), the pieces will tend to be saddle shaped unless changes are made to the fusion draw process. Notably, however, the above phenomenon is not obvious from viewing the gravity free (domed) shape of the larger glass sheet 20.

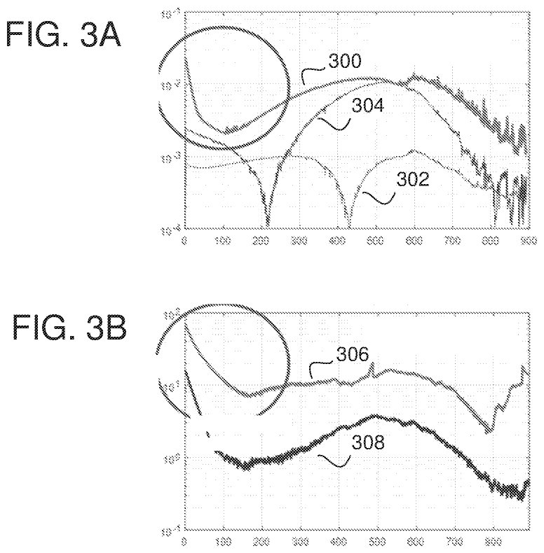

Notably, the shape estimated in FIG. 2C shares some similarities with another characteristic of the glass sheet 20, which is the intrinsic shape. The intrinsic shape is a shape determined by cutting a glass sheet into a plurality of smaller pieces, measuring the gravity free shapes thereof, and mathematically stitching the gravity free shapes together (using the aforementioned stitching script). It has been discovered, however, that the intrinsic shape of the glass sheet may be estimated without cutting it into smaller pieces. This discovery is based, in part, on the representative graphs of FIGS. 3A and 3B.

FIG. 3A is a representative graph of changes in pin height in a BON apparatus (the absolute change in height, plotted along the Y-axis) as a function if iteration (plotted along X-axis). The data are a result of running the aforementioned iterative algorithm on a glass sheet 10 measuring 1500 mm×1850 mm×1.0 mm on a BON apparatus represented by that shown in FIGS. 1A and 1B. The curve 300 is a plot of the absolute value of maximum height change of one or more of the height adjustable pins 102 as a function of iteration. The curve 302 is a plot of the absolute value of height change of a designated pin (e.g., pin #1) among the height adjustable pins 102 as a function of iteration. The curve 304 is a plot of the absolute value of height change of another designated pin (e.g., pin #30) among the height adjustable pins 102 as a function of iteration.

FIG. 3B is a representative graph (corresponding to the experiment run in connection with FIG. 3A) of weight error (in grams plotted along the Y-axis) as a function if iteration (plotted along the X-axis). The curve 306 is a plot of the maximum weight error of one or more of the load cells 104 as a function of iteration. The curve 308 is a plot of the median weight error of one or more of the load cells 104 as a function of iteration.

With a focus on the encircled portions of FIGS. 3A and 3B, one can ascertain some interesting information about the iterative algorithm employed by the BON technique. Specific attention is made to the situation in which next heights of the height adjustable pins are estimated based on the measured weights at each iteration and in a way seeking to zero out any weight errors. As can be seen in FIGS. 3A and 3B, the error initially decreases rapidly (indicating that the shape is converging), such that a minimum error occurs around iterations 100-200. Thereafter, the error increases, and then decreases again to the earlier levels near iteration 800. This evidences that the initial estimations for movement of the height adjustable pins 102 is in response to the weight distribution when the height adjustable pins 102 are generally horizontal (flat). In this position, the embedded thermal strain (which is in-plane stress/strain) of the glass sheet 10 has little or no effect on the normal force (weights) on the height adjustable pins 102. Thus, the initial estimations for movement of the height adjustable pins 102 (when they are generally flat), are converging on the intrinsic shape (not the gravity free shape). Once the iterative algorithm estimates the next heights of the height adjustable pins 102 sufficiently out of plane (sufficiently away from being flat, e.g., more than the thickness of the glass sheet), the embedded stress of the glass sheet 10 has an increasing effect on the normal force (weights) on the load cells 104. This causes the iterative algorithm to being the process of converging in another direction, i.e., eventually to the gravity-free shape of the glass sheet 10. The gravity free shape, therefore, is determinable from (and includes) both the intrinsic shape and the embedded thermal strain of the glass sheet 10.

As previously mentioned, the iterative algorithm measures the weight distribution when the glass sheet 10 is disposed on a relatively flat array of height adjustable pins 102, and then seeks to move the pins 102 to positions where the weight will match the target weights. At iteration zero, the initial weight measurements provide the solution as to the intrinsic shape of the glass sheet 10. Applying the iterative algorithm in the BON apparatus 100, once the glass sheet 10 moves out of plane (after the initial weight measurements are used to compute and move the height adjustable pins 102) the weight on the height adjustable pins 102 will reflect both the intrinsic shape and the in-plane stress. Thus, instead of converging to the intrinsic shape of the glass sheet 10, the height adjustable pins 102 converge to the gravity-free shape, which shows both effects.

In accordance with one or more embodiments herein, methods and apparatus provide for: (i) obtaining respective initial weight measurements on each of the plurality of load cells of a measurement gauge in response to an applied glass sheet 10 when the plurality of load cells are all at a constant initial height (flat); and (ii) estimating an intrinsic shape of the glass sheet 10 from the respective initial weight measurements.

In a general sense, the measurement gauge need not include height adjustable pins 102 (as in a BON apparatus) because at a minimum, only the initial weight measurements are necessary. Of course, the measurement gauge may be a BON apparatus, where the measurement gauge includes a plurality of height adjustable pins 102, each height adjustable pin associated with one of the plurality of load cells 104 as previously noted.

The estimation of the intrinsic shape of the glass sheet 10 may be achieved via: (i) computing a respective next height, away from the constant initial height, for each of the plurality of height adjustable pins 102 (and/or load cells 104) from the respective initial weight measurements, where the computing is based on the above-noted iterative algorithm for moving the height adjustable pins 102 to estimate a gravity free shape of the glass sheet 10; and (ii) estimating the intrinsic shape of the glass sheet 10 as a function of the respective next heights.

Another way of expressing the estimation of the intrinsic shape of the glass sheet 10 from the respective initial weight measurements is as follows:

$$- D ( \frac{{\partial }^{4} {w}_{0}}{\partial {x}^{4}} + 2 \frac{{\partial }^{4} {w}_{0}}{\partial {x}^{2} \partial {y}^{2}} + \frac{{\partial }^{4} {w}_{0}}{\partial {y}^{4}} ) = {\sum }_{1}^{N} {f}_{i} + ρ g h$$

where w₀ is the first intrinsic shape,

$$D = \frac{E {h}^{3}}{12 ( 1 - {v}^{2} )}$$

is a bending stiffness of the glass sheet, h is a thickness of the glass sheet, ρ is a density of the glass sheet, g is a gravity constant, E is a Young's modulus of the glass sheet, v is a Poisson ratio of the glass sheet, and fᵢ is the respective initial weight measurements.

The intrinsic shape may be validated by modeling. The information from the BON technique is the measured weight on the height adjustable pins and the predicted height of the intrinsic shape relative to a mean horizontal plane. The reciprocal problem may be modeled in commercially available software products, such as from ANSYS®, COMSOL®, or similar software, calculating the modeled force on the pins when a horizontal flat sheet with the correct dimensions, thickness, and glass properties (density, Young's modulus, Poisson's ratio, etc.) is deformed by moving the pins (in the model) to the positions predicted by the BON technique. The modeled reaction forces on the pins should agree with the measurement data from BON and they do.

In some cases, the BON technique may use a matrix calculated for a different thickness of glass sheet than the actual glass sheet in an experiment. In such case the ANSYS analysis will show the reaction forces differing by a ratio of [(thickness 1)/(thickness 2)]**2. The intrinsic shape can thus be corrected, and if thickness1 and thickness2 are known, the correction can be done without an ANSYS analysis.

The intrinsic shape can also be estimated through calculation more directly with a COMSOL, ANSYS, or similar model by applying the measured force error (relative to a flat horizontal plate) at the pin locations and calculating the change in shape.

A characteristic of the glass sheet that is associated with the intrinsic shape and the gravity free shape is the embedded thermal strain. The embedded thermal strain of the glass sheet occurs when different parts of the glass sheet crystalize (or freeze) at different times, and this characteristic can affect the shape of the glass sheet. In accordance with one or more embodiments herein, methods and apparatus provide for estimating an embedded thermal strain of the glass sheet. By way of example, the embedded thermal strain of the glass sheet may be estimated by: (i) obtaining measured stresses in the glass sheet when the glass sheet is forced flat; and (ii) estimating the embedded thermal strain as a function of the measured stresses and the intrinsic shape.

In connection with the above, a stress function obtained from the measured stresses may be expressed as a function of the intrinsic shape as follows:

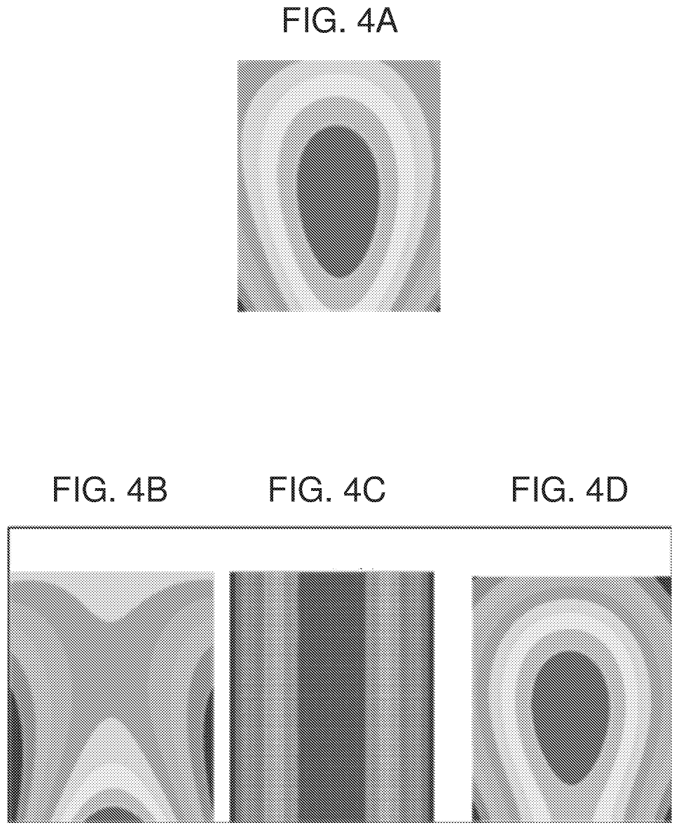

∇⁴φ=EK_{G}(w₀)−E∇²(αT),

where ∇⁴φ is the stress function, EK_{G} (w₀) is a Gaussian curvature of the intrinsic shape w₀, and E∇²(αT) is a term based on the embedded thermal strain, αT; and the estimate of the thermal strain is obtained by solving for a. In the above stress function, the only way that thermal strain has an effect on the outcome is via the 2^{nd} derivative E∇² (αT) (also connoted “Del-Squares alpha T”). Therefore, to estimate the effect of thermal strain, one need only to estimate “Del\hat{ }2 alpha T”. With reference to FIG. 4C, an alpha-T is being used, which is uniform in the vertical direction, and which only changes in the horizontal direction due to the formation of a glass sheet flowing down from a draw (i.e., variation down the draw is small compared to across the draw). Importantly, Del\hat{ }(of the function) is actually a constant, and many other functions would also result in a constant.

The estimated thermal strain may be tested and improved in accordance with methods and apparatus by: (a) comparing the estimate of the gravity free shape with a measured gravity free shape of the glass sheet to obtain an indication of an accuracy of the estimated embedded thermal strain of the glass sheet; (b) revising the estimated embedded thermal strain when the comparison indicates that the accuracy of the estimated embedded thermal strain is below a minimum, and re-estimating the gravity free shape of the glass sheet as a function of the intrinsic shape and the revised embedded thermal strain of the glass sheet; and (c) repeating steps (a) and (b) until the comparison indicates that that the accuracy of the estimated embedded thermal strain is at or above the minimum.

With reference to FIGS. 4A, 4B, 4C, and 4D, methods and apparatus disclosed herein may provide for estimating a gravity free shape of a glass sheet 10 as a function of the intrinsic shape and the embedded thermal strain of the glass sheet 10. FIG. 4A is a representative shaded schematic diagram of an actual gravity free shape of the glass sheet 10, which is dome shaped. Without actually measuring the gravity free shape of the glass sheet 10, and using the techniques discussed above, the intrinsic shape of the glass sheet 10 may be estimated (FIG. 4B) and used in relation to an estimate of the thermal strain of the glass sheet (FIG. 4C) to estimate the gravity free shape of the glass sheet 10 (FIG. 4D), which is also domed.

Advantageous results may be obtained using the discoveries discussed above, including methods and apparatus for estimating respective local gravity free shapes of smaller pieces of a larger glass sheet without cutting the larger glass sheet. In particular, the methods and apparatus provide for estimating the respective local gravity free shapes as a function of the intrinsic shape of the glass sheet. For example, each of the local gravity free shapes may be estimated by subtracting a respective one of a plurality of local mean planes from the intrinsic shape.

Advantageous results may be obtained using the discoveries discussed above, specifically when (as mentioned above) directly measuring the gravity free shape of a large glass sheet 20 on a BON apparatus is not possible. In this regard, the single, relatively large, glass sheet 20 is considered to include a plurality of glass sheets (if cut into smaller pieces), where the plurality of glass sheets includes a first applied glass sheet, a second applied glass sheet, etc.

The methods and apparatus herein provide for: (i) obtaining respective first initial weight measurements on each of a plurality of load cells of a measurement gauge in response to the first applied glass sheet when the plurality of load cells are all at a constant initial height (flat); and (ii) estimating a first intrinsic shape of the first glass sheet from the respective first initial weight measurements.

The methods and apparatus further provide for: (a) obtaining respective second initial weight measurements on each of the load cells of the measurement gauge in response to the second applied glass sheet when the plurality of load cells are all set to the constant initial height; (b) estimating a second intrinsic shape of the second glass sheet from the respective second initial weight measurements; and (c) repeating steps (a) and (b) for each of a plurality of applied glass sheets, to obtain a plurality of intrinsic shapes for the plurality of applied glass sheets.

The methods and apparatus further provide for: (a) applying a stitching script to obtain an estimate of a combined intrinsic shape that includes each of plurality of intrinsic shapes for the plurality of applied glass sheets matched at respective edges thereof; (b) estimating an embedded thermal strain of a combined glass sheet, where the combined glass sheet is estimated using a stitching script to combine the plurality of applied glass sheets matched at respective edges thereof; and (c) estimating a gravity free shape of the combined glass sheet as a function of the combined intrinsic shape and the embedded thermal strain.

The methods and apparatus further provide for the estimate of the embedded thermal strain of the combined glass sheet to be obtained by: (a) estimating a respective embedded thermal strain of each of the plurality of applied glass sheets; and (b) averaging the respective embedded thermal strain of each of the plurality of applied glass sheets to obtain the embedded thermal strain of the combined glass sheet.

Additionally or alternatively, the methods and apparatus further provide for the estimate of the embedded thermal strain of the combined glass sheet to be obtained by: (a) cutting a sub-section from a representative glass sheet, where the representative glass sheet is representative of the characteristics of the combined glass sheet and is of a larger square area than any one of the plurality of applied glass sheets; (b) applying the sub-section of the representative glass sheet onto a plurality of load cells of the measurement gauge; (c) obtaining respective initial weight measurements on each of the plurality of load cells in response to the sub-section of the representative glass sheet when the plurality of load cells are all set to a constant initial height; (d) estimating an intrinsic shape of the sub-section of the representative glass sheet as a function of initial weight measurements; (e) obtaining measured stresses in the sub-section of the representative glass sheet when the sub-section of the representative glass sheet; and (f) estimating the embedded thermal strain of the combined glass sheet as a function of the measured stresses and the intrinsic shape of the sub-section of the representative glass sheet.

Although the disclosure herein has been described with reference to particular embodiments, it is to be understood that these embodiments are merely illustrative of the principles and applications of the embodiments herein. It is therefore to be understood that numerous modifications may be made to the illustrative embodiments and that other arrangements may be devised without departing from the spirit and scope of the present application.

1. A method, comprising:
obtaining respective first initial weight measurements on each of a plurality of load cells of a measurement gauge in response to a first applied glass sheet when the plurality of load cells are all at a constant initial height (flat); and
estimating a first intrinsic shape of the first glass sheet from the respective first initial weight measurements.

2. The method of claim 1, wherein the measurement gauge includes a plurality of height adjustable pins, each height adjustable pin associated with one of the plurality of load cells.

3. The method of claim 1, wherein estimating the first intrinsic shape of the first glass sheet includes:
computing a respective next height, away from the constant initial height, for each of the plurality of load cells from the respective first initial weight measurements, where the computing is based on an iterative algorithm for moving height adjustable pins to estimate a gravity free shape of the first glass sheet; and
estimating the first intrinsic shape as a function of the respective next heights.

4. The method of claim 1, wherein the estimation of the first intrinsic shape of the first glass sheet from the respective first initial weight measurements may be expressed as:
$$- D ( \frac{{\partial }^{4} {w}_{0}}{\partial {x}^{4}} + 2 \frac{{\partial }^{4} {w}_{0}}{\partial {x}^{2} \partial {y}^{2}} + \frac{{\partial }^{4} {w}_{0}}{\partial {y}^{4}} ) = {\sum }_{1}^{N} {f}_{i} + ρ g h$$
where w₀ is the first intrinsic shape,
$$D = \frac{E {h}^{3}}{12 ( 1 - {v}^{2} )}$$
is a bending stillness of the first glass sheet, h is a thickness of the first glass sheet, ρ is a density of the first glass sheet, q is a gravity constant, E is a Young's modulus of the first glass sheet, v is a Poisson ratio of the first glass sheet, and fᵢ is the respective first initial weight measurements.

5. The method of claim 1, further comprising estimating a first embedded thermal strain of the first glass sheet.

6. The method of claim 5, further comprising estimating the first embedded thermal strain of the first glass sheet by:
obtaining measured stresses in the first glass sheet when the first glass sheet is forced flat; and
estimating the first embedded thermal strain as a function of the measured stresses and the first intrinsic shape.

7. The method of claim 6, wherein:
a stress function obtained from the measured stresses may be expressed as a function of the first intrinsic shape as follows:
∇⁴ϕ=EK_{G}(w₀)−E∇²(αT),
where ∇⁴ϕ is the stress function, EK_{G}(w₀) is a Gaussian curvature of the first intrinsic shape w₀, and E∇² (αT) is a term based on the first embedded thermal strain, αT; and
the estimate of the thermal strain is obtained by solving for α.

8. The method of claim 5, further comprising estimating a gravity free shape of the first glass sheet as a function of the first intrinsic shape and the first embedded thermal strain of the first glass sheet.

9. The method of claim 8, further comprising:
(a) comparing the estimate of the gravity free shape with a measured gravity free shape of the first glass sheet to obtain an indication of an accuracy of the estimated first embedded thermal strain of the first glass sheet;
(b) revising the estimated first embedded thermal strain when the comparison indicates that the accuracy of the estimated first embedded thermal strain is below a minimum, and re-estimating the gravity free shape of the first glass sheet as a function of the first intrinsic shape and the revised first embedded thermal strain of the first glass sheet; and
(c) repeating steps (a) and (b) until the comparison indicates that that the accuracy of the estimated first embedded thermal strain is at or above the minimum.

10. The method of claim 1, further comprising:
estimating a plurality of local gravity free shapes, each for a respective one of a plurality of sections of the first glass sheet, if the first glass sheet were cut into the plurality of sections,
wherein each of the local gravity free shapes is estimated as a function of the first intrinsic shape, and
wherein each of the plurality of local gravity free shapes is estimated by subtracting a respective one of a plurality of local mean planes from the first intrinsic shape.

11. The method of claim 1, further comprising:
(a) obtaining respective second initial weight measurements on each of the plurality of load cells of the measurement gauge in response to a second applied glass sheet when the plurality of load cells are all set to the constant initial height;
(b) estimating a second intrinsic shape of the second glass sheet from the respective second initial weight measurements; and
(c) repeating steps (a) and (b) for each of a plurality of applied glass sheets, to obtain a plurality of intrinsic shapes for the plurality of applied glass sheets, where the plurality of applied glass sheets includes at least the first applied glass sheet and the second applied glass sheet.

12. The method of claim 11, further comprising:
applying a stitching script to obtain an estimate of a combined intrinsic shape that includes each of plurality of intrinsic shapes for the plurality of applied glass sheets matched at respective edges thereof;
estimating an embedded thermal strain of a combined glass sheet, where the combined glass sheet is estimated using a stitching script to combine the plurality of applied glass sheets matched at respective edges thereof; and
estimating a gravity free shape of the combined glass sheet as a function of the combined intrinsic shape and the embedded thermal strain.

13. The method of claim 12, wherein the estimate of the embedded thermal strain of the combined glass sheet is obtained by:
estimating a respective embedded thermal strain of each of the plurality of applied glass sheets; and
averaging the respective embedded thermal strain of each of the plurality of applied glass sheets to obtain the embedded thermal strain of the combined glass sheet.

14. The method of claim 12, wherein the estimate of the embedded thermal strain of the combined glass sheet is obtained by:
cutting a sub-section from a representative glass sheet, where the representative glass sheet is representative of the characteristics of the combined glass sheet and is of a larger square area than any one of the plurality of applied glass sheets;
applying the sub-section of the representative glass sheet onto a plurality of load cells of the measurement gauge;
obtaining respective initial weight measurements on each of the plurality of load cells in response to the sub-section of the representative glass sheet when the plurality of load cells are all set to a constant initial height;
estimating an intrinsic shape of the sub-section of the representative glass sheet as a function of initial weight measurements;
obtaining measured stresses in the sub-section of the representative glass sheet when the sub-section of the representative glass sheet; and
estimating the embedded thermal strain of the combined glass sheet as a function of the measured stresses and the intrinsic shape of the sub-section of the representative glass sheet.
